(19) United States
(12) Patent Application Publication
(10) Pub. No.: US 2014/0346860 A1
(43) Pub. Date: Nov. 27, 2014

(54) INDUCTIVE POWER TRANSMISSION DEVICE

(71) Applicants: Anthony Aubry, Scionzier (FR); Frédéric Autran, Paris (FR)

(72) Inventors: Anthony Aubry, Scionzier (FR); Frédéric Autran, Paris (FR)

(73) Assignee: VALEO SYSTEMES THERMIQUES, Le Mesnil Saint Denis (FR)

(21) Appl. No.: 14/344,280

(22) PCT Filed: Sep. 11, 2012
(86) PCT No.: PCT/FR2012/000358

§ 371 Date: Apr. 4, 2014

(30) Foreign Application Priority Data
Sep. 12, 2011 (FR) 1102761

(51) Int. Cl. H02J 7/02; H04B 5/00; H02J 7/00

(52) U.S. Cl. CPC H02J 7/025; H02J 7/007; H04B 5/0037; H02J 7/0042
USPC 307/9.1; 307/104

(57) ABSTRACT

The invention relates to a single device (500) combining the functions of an inductive power transmitter for recharging a mobile device and of near-field data communication (NFC) with said mobile device. Said device comprises at least the following elements: a) an inductive power transmission module (500) for transmitting power to a mobile device (600), including: a power transmission coil (110); a first device (120) for communicating between the power transmission module and the mobile device; and a device (130) for monitoring the charge of the mobile device; b) a second near-field communication device including: a data transmission coil (310); a second device (320) for communicating between the data transmission module and the mobile device; and a device (330) for controlling the exchanges of information with the mobile device; and c) a base (502) for receiving the mobile device.

The present invention concerns a power transmission module combined with a near-field communication module.

It is known practice to use power transmission modules in order to power or charge the battery of nomadic devices such as portable telephones.

In view of the multiplication of nomadic models, the use of a wireless charging device using the transfer of power by an inductive means has the advantage of allowing freedom from the use of chargers that are specific to each nomadic model.

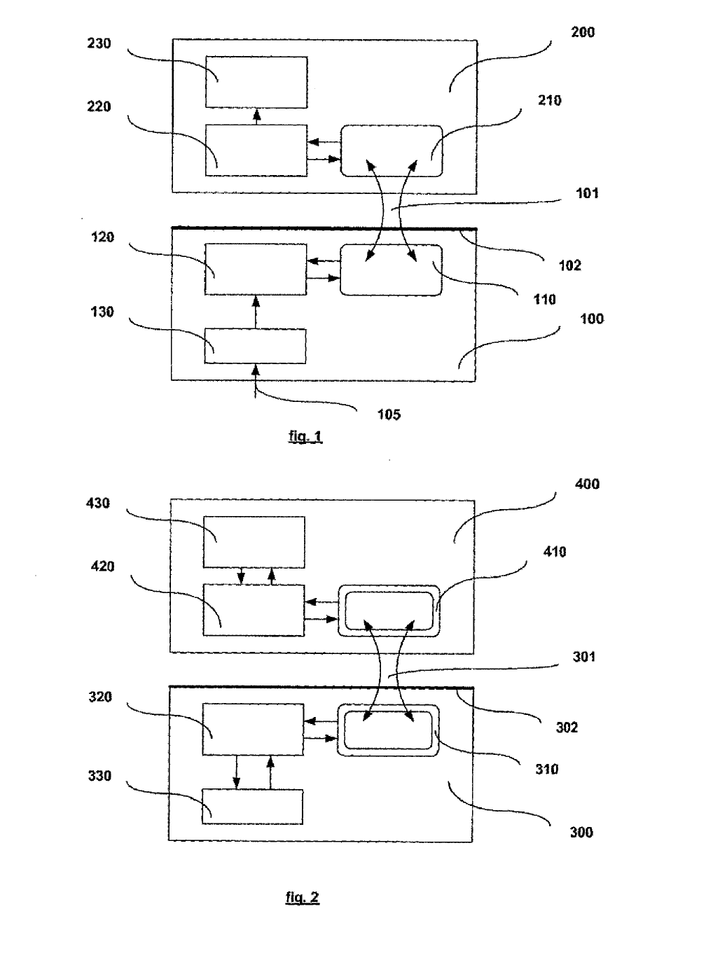

Such wireless inductive power transmitters are known both for uses within buildings, such as private homes, and for uses in motor vehicle passenger compartments. FIG. 1 shows the operation of such a power transmission module 100 mounted in a base 102 and cooperating with a nomad 200, in this case a portable telephone. The power transmission module 100 has a transmission coil 110 and the nomad 200 has a reception coil 210. In order to transmit power to the nomad 200, an alternating current is passed through the transmission coil 110 so as to produce a magnetic field 101. This magnetic field 101 travels through the coil 210 of the nomad and produces a voltage within said coil. The voltage thus produced can then be used to power the nomad or else to charge the battery of the latter.

In order to save energy, the magnetic field 101 must not be emitted the entire time, because, in view of the power to be emitted, the demand for current is fairly high. For this reason, such a power transmitter is configured to produce a magnetic field only when the two coils 110 and 210 are placed one opposite the other. To this end, the power transmission modules and the nomad each have communication devices 120 and 220, respectively, that allow the two devices to communicate with one another. These communication devices 120 and 220 each comprise a transmission device and a reception device. In this case, by way of example, these transmission and reception devices comprise circuits for modulating and demodulating the frequency or amplitude of communication signals intended to be sent on the carrier created by the magnetic field 101. The basic principle involves emitting the magnetic field 101 only when the presence of a nomad has been detected on the base 102 of the power transmission module. In order to effect this detection, the communication device 120 of the power transmission module emits, according to a predetermined fixed period, a polling signal “ping” to the location reserved on the base 102 for the nomad. While no nomad is present on the base, the receiver 120 of the power transmitter does not detect a return signal and does not send power. In this case, the carrier 101 carrying the modulated communication signals is at low power, namely at a power much lower than that required for powering or charging the battery of a nomad such as a portable telephone. As soon as a nomad is placed onto the base 102 and the two coils 120, 220 are situated opposite one another, the power transmitted by the magnetic field 101 wakes up the charging control device 230 of the nomad, which, in response to reception of the polling signal “ping”, sends a presence signal for the nomad to the power transmission module. By way of example, this presence signal may involve an identifier stored permanently in the nomad and representing the detected nomad. As soon as this presence signal is detected by the power transmission module 100, the latter generates a magnetic field 101 that is suited to the detected nomad by virtue of the charging control device 130 of the power transmission module, which adapts the power of the magnetic field on the basis of the received identifier. While the power transmission is being carried out, the power transmission module and the nomad communicate with one another so as to verify that the nomad is indeed still present on the base 102 of the power transmitter. Thus, the communication device 120 periodically sends a polling signal “ping”, and the nomad responds as present by sending a return message, in this case the identifier by way of example. As soon as the nomad is picked up, the return signal no longer reaches the power transmission module and the power of the magnetic field 101 is decreased so that it is just necessary to be of use as a carrier for the modulated communication signals, notably the polling signal “ping”. The nomad can likewise send a signal representing the end of charging of its battery to the power transmitter and, as in the case of the nomad being picked up, the charging control device 130 decreases the power of the magnetic field 101 in order to limit it to its role as a carrier for the modulated signals.

As can be seen, such a power transmission module is entirely autonomous and is self-sufficient. It is not necessary to take external action to start up the power transmission, and the communication takes place transparently for the user whatever the environment in which this power transmission module is placed; whether placed in a house or a motor vehicle, its operation remains identical.

Moreover, it is also known practice to use near-field communication readers for interchanging information with another device that are separated by a distance not exceeding ten or so centimeters. An example of this type of communication is known by the term NFC (Near Field Communication). This type of close communication, limited to very short distances, is used in applications dedicated to transport, for example. Thus, transport cards or badges are equipped with NFC devices that the users pass in front of dedicated readers so as to be able to access the platforms. These devices that equip nomads such as badges, access cards or mobile telephones are called “tags”. They are composed of a transmission/reception antenna and a logic circuit for controlling the tag that may likewise an area for storing information intended to be interchanged with a tag reader.

The fact that the range of the communication is limited to a very short distance has the advantage that an NEC badge reader can recognize only badges that are voluntarily placed in front of the reading area provided to this end. It is thus not possible for there to be undesired reading of a badge that, for example, is carried by another person situated at too great a distance from the badge reader. It is a security device based on very short-distance communication.

Such near-field communication devices (which are called NFCs below) are already known for telephone applications in which, by way of example, NFC tags are placed on nomadic telephones so as to perform commercial transactions, for example.

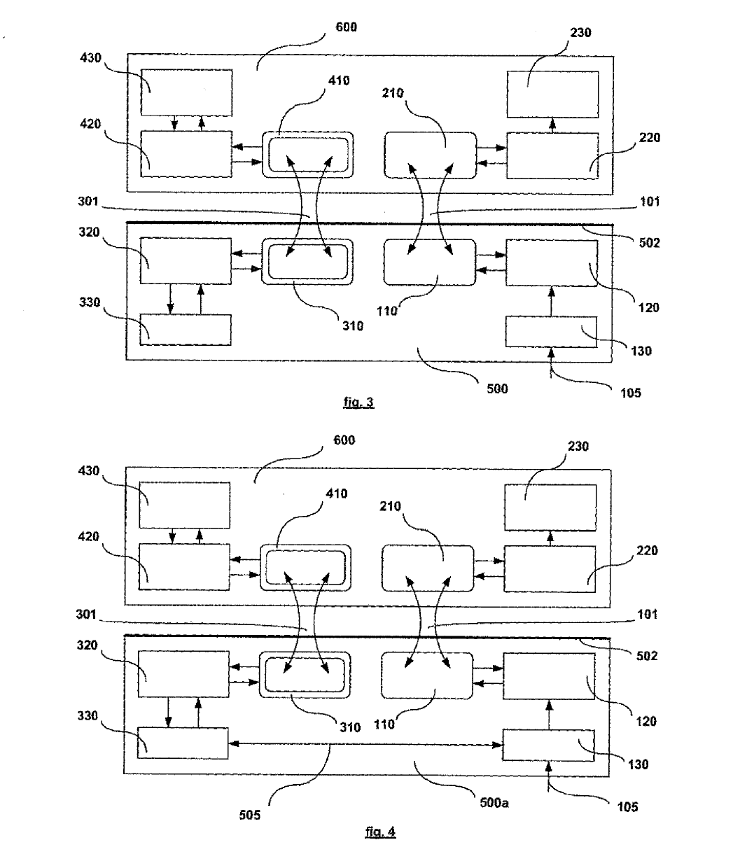

FIG. 2 shows the operation of such an NFC tag reader 300 having a base 302 and cooperating with a nomad 400 that is equipped with an NFC transmission/reception module constituted by an NFC tag, for example.

The tag reader 300 has a transmission/reception coil 310 and the nomad 400 has a transmission/reception coil 410, for example placed inside the nomad in the form of a tag. A tag generally takes the shape of a label that has an antenna and a logic circuit. As a variant, the tag may be replaced by a control circuit for the nomad that simulates the operation of a tag. In this case, the tag simulated in this manner can cooperate with other functionalities of the nomad such as a portable telephone.

In order to transmit a message to the nomad 400, a current is passed through the transmission/reception coil 310 of the tag reader 300 so as to produce a magnetic field 301. This magnetic field 301 travels through the coil 410 of the tag of the nomad and produces a voltage within said coil 410. This field needs to be sufficiently powerful to power the circuit of the tag.

The tag readers and the nomad each have communication devices 320 and 420, respectively, that allow the two devices to communicate with one another. These communication devices 320 and 420 each comprise a transmission device and a reception device. In this case, for example, these transmission and reception devices comprise circuits for modulating and demodulating the frequency or amplitude of communication signals intended to be sent on the carrier created by the magnetic field 301.

The communication device 320 of the tag reader 300 emits, according to a predetermined fixed period, a polling signal “ping” in a reading area situated around the base 301. As long as there is no nomad situated at the minimum distance for setting up NFC communication, the receiver of the communication circuit 320 of the tag reader 300 does not detect a return signal.

As soon as a nomad is placed inside the communication area, the power transmitted by the magnetic field 301 wakes up the control device for the tag 430 of the nomad, which, in response to reception of the polling signal “ping”, sends a presence signal for the nomad to the tag reader 300. By way of example, this presence signal may involve an identifier stored in an NVRAM (Non Volatile Ram), for example integrated in the electronic component of the NFC tag of the nomad.

Unlike Bluetooth® communication, which takes place at greater distances between the nomad and the reader, NFC communication takes place at close distances. For this reason, it may prove useful for indicating the presence of the tag in an area close to the tag reader.

However, although having different purposes—power transmission for the first, data interchange for the second—, these two devices have considerable similarities in operation.

Particularly for the first, in order to ensure a good level of efficiency for the power transmission between the transmitter module 100 of the induction charger and the receiving nomad 200, it is necessary to have good physical coupling between the coils of the transmitter 110 and the receiver 210. That is to say that, in practice, the distance between the two coils needs to be less than 5 mm.

This entails a constraint for the user, who needs to ensure that the nomad 200 is correctly positioned on the base 102 of the power transmitter 100.

Equally, for the second, in order to ensure correct data interchange between the near-field communication device (NEC) and the nomadic equipment, it is necessary, there again, to ensure a good level of coupling between the coil (or antenna) 310 of the NFC reader and the coil (or antenna) 410 of the nomad.

This requires the nomadic piece of equipment to be positioned on the base 102 of the inductive charging device (FIG. 1) or the base 302 of the near-field communication device (FIG. 2) corresponding to the function that is intended to be implemented.

It is an aim of the invention to allow these two devices to be used with a single nomad at the same time as the user needs to change the position of the nomad.

This is realized by combining in the same piece of equipment all of the devices allowing the functions of power transmission and near-field data communication to be provided. That is to say, as shown in FIG. 3, by incorporating into one and the same piece of equipment 500, under one and the same base 502 that is intended to receive the nomadic piece of equipment, the following elements:
a power transmission coil (110),
a first communication device (120) between the power transmission module and the nomad,
a control device (130) for the charging of the nomad,
a data transmission coil (310),
a second communication device (320) between the data transmission module and the nomad,
a control device (330) for the information interchanges with the nomad.

This feature is of quite particular benefit in the field of automobiles, where the safety of the users makes it necessary to avoid manipulating a nomadic appliance while driving the vehicle.

This feature will also allow space to be gained in the vehicle and a contribution to improving capacity in the vehicle without sacrificing the functions provided for the users. Finally, this feature makes it possible to reduce the weight and therefore to contribute to reducing fuel consumption.

In the same way, there will be a benefit in the home for avoiding the comings and goings of nomadic pieces of equipment between several stations. This will moreover allow a reduction in the cabling needs by limiting the number of power sockets necessary for powering pieces of inductive charger 100 and short-range communication reader 300 (NFC) equipment.

Another advantage of this combination is a reduction in standby consumption through the reduction in the number of pieces of equipment on standby, a single piece of equipment rather than two pieces of equipment requiring a permanent power supply called a standby power supply. Although generally minimal, this standby consumption may no longer be negligible if considered over a long period such as a year, because it is permanent. It is not rare for this standby consumption to exceed the useful consumption of the piece of equipment under consideration on average over a year.

The subject of the invention is a piece of equipment having at least
a—an inductive power transmission module intended to transmit said power to a nomadic piece of equipment, said module comprising:
   a power transmission coil,
   a first communication device between the power transmission module and the nomad,
   a control device for the charging of the nomad,
b—a second near-field communication means comprising:
   a data transmission coil,
   a second communication device between the data transmission module and the nomad,
   a control device for the information interchanges with the nomad,
c—a base intended to receive the nomad,
   in which
   the power transmission and data coils are arranged in said base so as to simultaneously allow the transmission of power and the interchange of data with said nomadic piece of equipment put onto said base.

The power transmission device may moreover have one or more of the following features, taken separately or in combination:

The control device for the charging of the nomad and the control device for the information interchanges with the nomad are linked by a means that allows information to be interchanged so as to improve the operation of the set.

The power transmission coil and the data transmission coil are arranged one on top of the other so as to minimize the contact area for the base with the nomad.

The power transmission coil and the data transmission coil are combined into a single coil that possibly has intermediate sockets so as to minimize the contact area for the base with the nomad and the dimensions of the piece of equipment.

The piece of equipment is integrated into a piece of equipment in a motor vehicle with which it shares at least the base.

The piece of equipment is integrated into a piece of equipment in a motor vehicle with which it shares at least one electronic function such as a connector, a regulated power supply, or a microprocessor.

The piece of equipment in the vehicle in which it is integrated is a control panel for the passenger compartment.

The piece of equipment in the vehicle in which it is integrated is a cladding element for the passenger compartment.

The removable piece of equipment is transportable and provided for autonomous use requiring only a power supply by an external source.

The removable piece of equipment is powered by a cigar lighter in the motor vehicle. The removable piece of equipment is powered by a power wire in a motor vehicle.

The removable piece of equipment is powered by the mains power supply of a building.
The control systems for the two systems—the inductive power transmitter and the near-field communication (NFC) badge reader—are linked by an information interchange means that will allow the synergy of operation of these two systems to be improved.
The transmission coils (or antennas) of the two systems—the inductive power transmitter and the near-field communication (NFC) badge reader—included in the piece of equipment may be superimposed so as to reduce the dimensions thereof on the reception base of the nomad, and consequently to allow more compact nomad use.
The transmission coils (or antennas) of the two systems—inductive power transmitter and near-field communication (NFC) badge reader—included in the piece of equipment may be combined into a single coil (or antenna) so as to reduce the dimensions of the piece of equipment, and consequently to allow the weight and cost thereof to be reduced.
The piece of equipment can be used advantageously in a motor vehicle, where it may be combined with pieces of equipment that already exist in the vehicle, such as, by way of example, a control panel for the dashboard, or else, still by way of example, a cladding element for the passenger compartment, like the glove box, the door, or else the central console situated between the seats, inter alia.
The piece of equipment will advantageously be able to share mechanical functions like the base 502 or else electronic functions such as a connector, a power supply regulation circuit or else a microcontroller, inter alia, with these pieces of equipment in the motor vehicle.
The piece of equipment will be able to be proposed in a removable version that can be transported in a motor vehicle or in the home by taking its power source from a cigar lighter socket in the motor vehicle, for example, or else from a power wire in the motor vehicle, or else from the mains power supply of a building, inter alia.

Other features and advantageous of the invention will emerge from the description below, given by way of example, without being limiting, with regard to the appended drawings, in which:

FIG. 1 schematically shows an inductive power transmitter according to the prior art,

FIG. 2 schematically shows a near-field communication (NFC) badge reader according to the prior art,

FIG. 3 schematically shows the piece of equipment combining an inductive power transmitter and a near-field communication (NFC) badge reader according to the invention,

FIG. 3 schematically shows the piece of equipment combining an inductive power transmitter and a near-field communication (NFC) badge reader according to the invention,

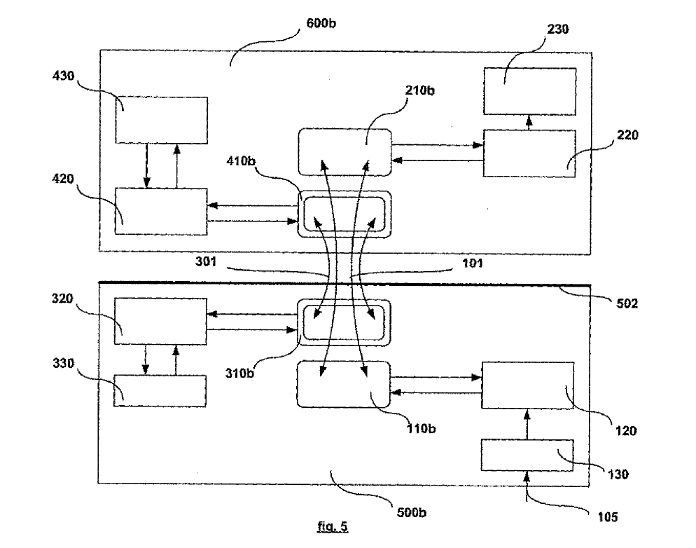

FIG. 4 schematically shows the piece of equipment combining an inductive power transmitter and a near-field communication (NFC) badge reader, the control systems of which are linked by an information interchange means 505 according to an improvement of the invention,

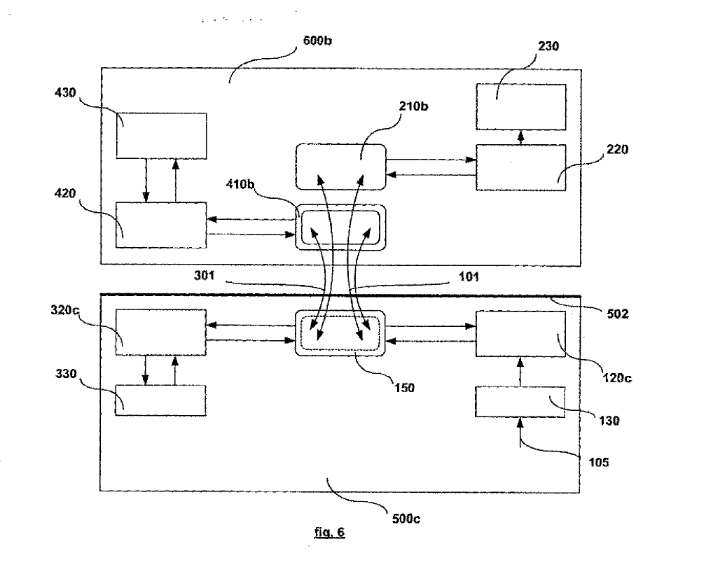

FIG. 5 schematically shows another implementation example of the piece of equipment combining an inductive power transmitter and a near-field communication (NFC) badge reader, the coils (or antennas) of which are arranged one on top of the other in the piece of equipment allowing a reduction in the surface area of the base in contact with the nomad according to the invention,

FIG. 6 schematically shows another implementation example of the piece of equipment combining an inductive power transmitter and a near-field communication (NEC) badge reader, the coils (or antennas) of which have been merged into a single coil (or antenna) in the piece of equipment allowing a reduction in the volume of said piece of equipment according to the invention.

The identical numbers in the various figures denote the same technical features.

FIG. 1 described above shows an inductive power transmitter 100 having a first communication means that allows it to communicate with the outside, namely with the nomad 200 for which it needs to transmit the power. These first communication means have the coil 110 that provides the carrier for the signals modulated by the control logic 130 and modulation means 120 that are capable of modulating and demodulating signals interchanged with the nomad 200. The coil 110 is placed near to the base 102 that allows the nomad to be received so as to ensure a good level of coupling with the coil 210 of the nomad and to limit the losses of the magnetic field 101. The power to be transmitted to the nomad is provided in this example by an external source via a link 105.

FIG. 2 described above shows a near-field communication (NFC) badge reader 300 having a first communication means that allows it to communicate with the outside, namely with the nomad 400 with which it interchanges information. These first communication means have the coil 310 that provides the carrier for the signals modulated by the control logic 330 and modulation means 320 that are capable of modulating and demodulating signals interchanged with the nomad 400. The coil (or antenna) 310 is placed near to the base 302 that allows the nomad to be received so as to ensure a good level of coupling with the coil or antenna 410 of the nomad and to limit the losses of the magnetic field 301.

According to a first exemplary embodiment shown in FIG. 3, the piece of equipment 500 comprises under a base 502 that is intended to receive a nomadic piece of equipment 600: a power transmission coil 110 that is intended to charge said nomad 600, alongside a coil (or antenna) 310 for data communication with said nomad 600. The magnetic field 101 produced by the power transmission coil 110 is controlled by a communication module 120 that is responsible for modulating said field 101 on the basis of the charging control module 130. In this embodiment, the power source is, by way of example, provided by the outside of the piece of equipment 500 by means of a power link 105 such as a mains power supply cord in a building or else in others a cigar lighter cord in a motor vehicle.

The magnetic field 101 produced by said power transmission coil 110 travels through the base 502 and generates a power signal in the coil 210 of the nomad 600 situated opposite. This power signal is used in order to power the communication 220 and charging control 230 circuits of the nomad 600. As has been described previously, the control module 230 responds by using the same channel (220, 210, 101, 110, 120) to send information to the control module 130 of the power transmitter confirming to it the need for power to charge the battery of the nomad 600.

Equally, the magnetic field 301 produced by the data communication coil 310 is controlled by a communication module 320 that is responsible for modulating said field 301 on the basis of the communication control module 330.

The magnetic field 301 produced by the data 310 communication coil (or antenna) 310 travels through the common base 502 and generates a communication signal in the coil 410 of the nomad 600, which coil is situated opposite. This data communication signal is used to power the communication 420 and communication control 430 circuits of the nomad 600. As has been described previously, the control module 430 responds by using the same channel (420, 410, 301, 310, 320) to send information to the data communication control module 330 confirming to it the need to communicate on the basis of the communication protocols that are defined, by way of example, by the NFC-type standards in order to interchange information with the nomad 600.

For optimum operation of this device, it is important that the various coils are arranged opposite one another, that is to say 110 facing 210 and 310 facing 410.

According to a second exemplary embodiment that is shown by FIG. 4, the control module 130 for the inductive power transmitter (110, 120, 130) and the control module 330 for the near-field communication (NFC) badge reader module (310, 320, 330) are linked by an information interchange means 505 that allows the synergy of operation of these two systems to be improved. By way of example, this communication means may be a communication bus (among others: 12C, CAN, SRI, etc.) or else direct wire links.

According to a third exemplary embodiment that is shown by FIG. 5, the coil (or antenna) 310b of the near-field communication (NFC) badge reader (310b, 320, 330) has been placed above the coil 110b of the inductive power transmitter (110b, 120, 130), which allows a reduction in the dimensions on the reception base 502 of the nomad 600b.

It should be noted that the coils of the nomad will have to be placed consistently, that is to say, as shown in FIG. 5, the reception coil for the power 210b above the communication coil 410b of the near-field transmission system. This arrangement shown by way of example is preferable (performs better) than the inverse arrangement by placing the power coils (110b, 210b) between the communication coils (310b, 410b), which is nevertheless still conceivable.

This exemplary embodiment has the advantage of allowing the provision and use of a more compact nomad and the provision of a more compact piece of equipment 500b.

According to a fourth exemplary embodiment that is shown by FIG. 6, the coil (or antenna) of the near-field communication (NFC) badge reader (150, 320c, 330) and the coil of the inductive power transmitter (150, 120c, 130) are provided by a single coil or antenna 150 that provides the two functions, which moreover allows a reduction in the volume of the device in the piece of equipment 500c.

It should be noted that it is possible to use a single coil with intermediate sockets to facilitate adaptation to the various frequencies that are involved in the two transmission systems (high frequencies for the NFC, low ones for the power transmission).

This exemplary embodiment has the advantage of allowing a reduction in the weight and cost of the piece of equipment 500c.

1. A piece of equipment comprising:
an inductive power transmission module intended to transmit said power to a nomadic piece of equipment, said module comprising:
a power transmission coil, and
a first communication device between the power transmission module and the nomad,
a control device for the charging of the nomad;
a second near-field communication means comprising:
a data transmission coil,
a second communication device between the data transmission module and the nomad, and
a control device for the information interchanges with the nomad; and
a base intended to receive the nomad, characterized in that wherein the power transmission and data coils are arranged in said base so as to simultaneously allow the transmission of power and the interchange of data with said nomadic piece of equipment put onto said base.

2. The piece of equipment as claimed in claim 1, wherein the control device for the charging of the nomad and the control device for the information interchanges with the nomad are linked by a means that allows information to be interchanged so as to improve the operation of the set.

3. The piece of equipment as claimed in claim 1, wherein either the power transmission coil and the data transmission coil are arranged one on top of the other so as to minimize the contact area for the base with the nomad.

4. The piece of equipment as claimed in claim 1, wherein the power transmission coil and the data transmission coil are combined into a single coil that possibly has intermediate sockets so as to minimize the contact area for the base with the nomad and the dimensions of the piece of equipment.

5. A control panel for the passenger compartment of a motor vehicle, wherein the control panel incorporates a piece of equipment as claimed in claim 1, of which it shares at least the base.

6. The control panel as claimed in claim 5, wherein the control panel shares at least one electronic function selected from the group consisting of a connector, a regulated power supply and a microprocessor, with the piece of equipment.

7. A cladding element for the passenger compartment of a motor vehicle, wherein the cladding element incorporates a piece of equipment as claimed in claim 1, of which it shares at least the base.

8. The cladding element for a motor vehicle as claimed in claim 7, wherein the cladding element shares at least one electronic function, such as a connector, a regulated power supply or a microprocessor, with the piece of equipment.

9. The piece of equipment as claimed in claim 1, wherein the piece of equipment is transportable, removable and provided for autonomous use requiring only a power supply by an external source.

10. The piece of equipment as claimed in claim 9, wherein the piece of equipment is powered by a cigar lighter in a motor vehicle.

11. The piece of equipment as claimed in claim 9, wherein the piece of equipment is powered by a power wire in the motor vehicle.

12. The piece of equipment as claimed in claim 9, wherein the piece of equipment is powered by the mains power supply of a building.
